(19) United States
(12) Patent Application Publication
(10) Pub. No.: US 2011/0166942 A1
(43) Pub. Date: Jul. 7, 2011

(54) CONTRACT AUCTIONS FOR SPONSORED SEARCH

(75) Inventors: Serguei Vassilvitskii, New York, NY (US); Sebastien Lahaie, Rye, NY (US); Sharad Goel, New York, NY (US)

(73) Assignee: Yahoo!, Inc., a Delaware corporation, Sunnyvale, CA (US)

(21) Appl. No.: 12/683,247

(22) Filed: Jan. 6, 2010

(51) Int. Cl. G06Q 30/00; G06Q 20/00

(52) U.S. Cl. 705/14.71

(57) ABSTRACT

Example methods, apparatuses, and articles of manufacture are disclosed that may be used to provide or otherwise support contract auctions for sponsored search advertising for use in auction management systems.

### BACKGROUND

1. Field

The present disclosure relates generally to auction management systems and, more particularly, to pricing for auction management systems in electronic marketplaces.

2. Information

Sponsored search is a large and rapidly growing advertising platform and a major source of revenue generated over the Internet by search engine companies and/or publishers. With a high volume of Internet searches performed every day, search results web pages may represent a commercially-viable advertising medium allowing advertisers to achieve complex advertising goals (e.g., build brand awareness, attract specific customers, target segmented markets, generate web traffic, implement behavioral targeting, etc.).

Typically, although not necessarily, sponsored search advertising may involve an advertisement provider or publisher, such as, for example, a search engine Yahoo! Search™, running an auction among multiple advertisers to sell an advertising inventory or space on its search results web pages returned to a user in response to one or more search terms (e.g., a query). To participate in these auctions, advertisers may select one or more keywords that are descriptive of or otherwise related to their businesses, and may submit bids on each of such keywords to have their advertisement shown next to the search results when a user's query matches a particular keyword.

Advertisers' bids may affect the selection and/or relative placement (e.g., to positions or slots relative to other advertisements) of their respective advertisements on a search results web page, and a publisher may charge advertisers according to one or more pricing rules and/or transaction mechanisms. Such mechanisms may include, for example, a cost-per-click (CPC) pricing in which an advertiser may pay a publisher every time a search engine user clicks on a displayed advertisement. Another example is a cost-per-impression (CPM) pricing that may allow a publisher to charge an advertiser according to the number of times (e.g., a thousand, etc.) its advertisement is shown to search engine users (e.g., for a chance to be viewed by and/or to make an impression on potential customers). Optionally or alternatively, a publisher may charge an advertiser when the displaying of a particular advertisement leads to some desired event or action by a search engine user on the advertiser's web site (e.g., sale of an advertised product, participation in surveys or sweepstakes, subscribing to a magazine or newsletter, etc.) in accordance with a cost-per-action (CPA) pricing, for example. These pricing mechanisms, however, may be less than optimal in terms of enhancing expected revenue of a publisher given the strategic nature of advertisers' bids while increasing advertisers' return for a given advertising budget (e.g., the number of clicks, impressions, purchases, etc. per daily or weekly cost incurred). In addition, for some advertisers, one-dimensional bids (e.g., restricted to bidding on only one feature, such as, CPC, or CPM, or CPA, etc.), for example, may not be sufficiently expressive to convey their valuations or preferences.

Revenue from sponsored search advertising may drive innovation that occurs in Internet technology in general, and search engine services in particular. Accordingly, as Internet commerce evolves, it may be desirable to develop one or more methods, systems, and/or apparatuses that implement efficient pricing and/or transaction mechanisms which may improve the overall efficiency of the auction market (e.g., by reducing or eliminating strategic bidding behavior, etc.) while increasing publishers' revenue and/or optimizing advertisers' return on investments.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating certain features and/or processes associated with an example computing environment according to one implementation.

FIG. 2 is a flow diagram illustrating an example contract auction process according to one implementation.

FIG. 3 is a schematic diagram illustrating certain features of the process of FIG. 2.

FIGS. 4 and 5 illustrate price determination for a final impression-plus-click contract.

FIG. 6 is a schematic diagram illustrating an exemplary computing environment associated with one or more special purpose computing apparatuses supportive of the process of FIG. 2.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, and articles of manufacture are disclosed herein that may be used for selection and/or pricing of advertisers' bids for sponsored search auctions. As used herein, “sponsored search” may refer to a form of search engine marketing and/or advertising (e.g., textual, graphical, etc.) that may increase the visibility and/or marketability of advertisers' products, for example, by placing targeted advertisements (e.g., contextual, geographic, demographic, etc.) on search terms (e.g., queries) next to a listing of search results in returned search result web pages. As will be described in greater detail below, a selection and/or assignment of advertisements to certain positions or slots within a web page may be determined by an on-line auction among advertisers that bid on specific keywords that match a query. As used herein, “advertiser,” “bidder,” and/or the plural form of such terms may be used interchangeably and may refer to an individual person or persons and/or entities that may be capable of participating, directly or indirectly (e.g., via an agent, etc.), in a market for on-line and/or off-line advertising inventory or space and/or may benefit from such participation. In some implementations, an auction may provide one or more techniques for determining a price that one or more winning advertisers may pay to an advertisement provider or publisher, as will also be seen.

Before describing some example methods, apparatuses, and articles of manufacture in greater detail, the sections below will first introduce certain aspects of an example operating environment, computing or otherwise, in which sponsored search auctions may be performed in particular implementations. It should be appreciated, however, that techniques provided herein and claimed subject matter is not limited to these example implementations. For example, techniques provided herein may be adapted for use in a variety of information processing environments (e.g., electronic exchange, database applications, etc.), as well as in off-line transaction models (e.g., book publishing, insurance, executive compensation, etc.), as will be seen. In addition, any implementations and/or configurations described herein as “example” are described for purposes of illustrations and are not to be construed as preferred or desired over other implementations and/or configurations.

Considering the enormous amount of information available on the World Wide Web, it may be desirable to employ one or more search engine services to help a user to locate and efficiently retrieve one or more web documents that may be of particular and/or possible interest to such a user. A “web document,” as the term used herein, is to be interpreted broadly and may include one or more signals representing any source code, search result, advertisement, file, and/or data that may be read by a special purpose computing apparatus during a search and that may be played and/or displayed to a search engine user. As a way of illustration, web documents may include a web page, an e-mail, an Extensible Markup Language (XML) document, a media file (e.g., a graphical advertisement, etc.), or the like, or any combinations thereof, just to name a few examples. A web page may also contain one or more embedded references (e.g., hyperlinks) to text, images, audio, video, and/or other web documents, for example.

As a way of illustration, a search engine user may submit or otherwise specify one or more search terms (e.g., a query) into a search engine and may receive and view a web page including a set of search results listed in a particular order. A user may subsequently access a particular web document by clicking on or otherwise selecting a hyperlink or other selectable tool embedded in or otherwise associated with such a document. As used in the present application, “click” or “clicking” may refer to a selection process made by any pointing device, such as, for example, a mouse, track ball, touch screen, keyboard, or any other type of device operatively enabled to select one or more web documents, for example, within a search results web page via a direct or indirect input from a user.

In some implementations, a returned search results web page may include one or more sponsored sections or portions incorporating a listing of paid or sponsored advertisements that may be related to users' queries. Sponsored advertisements may comprise, for example, selectable text links that may be arranged linearly down the page (e.g., from top to bottom) presented with a listing of search results. It should be appreciated that sponsored advertisements may include any form of advertisements utilized by an on-line advertising industry, such as static or animated banners (e.g., display advertisements), text messages, e-mail messages, etc., just to name a few examples. In addition, advertisements may include a title, an abstract, a product description, a logo, and/or other related objects to assist a search engine user in deciding whether to access a particular web document.

As was indicated, advertisement providers or publishers (e.g., search engine companies) may use one or more processes and/or transaction mechanisms to facilitate selling and/or pricing of their advertisement inventory or space to on-line advertisers. For example, a publisher may auction off an advertising space on its search result web pages. An “auction,” as the term used herein, is to be interpreted broadly and may refer to an on-line and/or off-line market institution and/or transaction mechanism with an explicit set of rules (e.g., winner determination, pricing/payment, bid recording/managing, etc.) determining resource allocation and prices on the basis of bids from the market participants.

In a sponsored search auction, advertisers may select one or more keywords that may be descriptive of a business that advertisers may wish to promote and/or that may be associated with products that advertisers may wish to sell. For a specific keyword, then, advertisers may submit bids—along with respective advertisements—stating their maximum willingness to pay, for example, when their advertisement is displayed (e.g., per-impression or CPM bidding and/or pricing) or clicked on (e.g., per-click or CPC bidding and/or pricing) by a search engine user. Under some circumstances, it may be desirable for an advertiser to pay a publisher contingent on a search engine user completing a certain transaction on an advertiser's web site (e.g., per-action or CPA bidding and/or pricing), for example, by purchasing an advertised product, as previously mentioned.

As will be described in greater detail below, keywords and bids submitted by advertisers may be collected and/or stored in respective databases associated with advertiser accounts that may be maintained by an advertisement provider or publisher. When a search engine user searches a corpus of documents, for example, utilizing public networks (e.g., the Internet, the World Wide Web) or private networks (e.g., intranets) for a particular search term that matches a keyword on which advertisers placed their bids, a set of sponsored search advertisements or results may be displayed to a user on the returned search results page. As will be seen, sponsored search results may be ranked based, at least in part, on an expected revenue function of advertisers' bids and may be displayed in decreasing order of the bids with the winning advertisement displayed more prominently among other sponsored search results (e.g., most likely to be seen by a user and/or most likely to be clicked on, etc.).

In some implementations, a publisher may utilize one or more techniques and/or processes to perform winner determination. For example, a publisher may maintain an estimate of a probability of a user clicking on an advertisement for each keyword selected by advertisers and may assign the most prominent advertising position or slot (e.g., the winning bid) to an advertiser that has the highest product of the per-click bid and the estimated click-through rate (e.g., the highest expected revenue from an advertisement A), or:

R_{E}^{A}=p(click|A,seen)×CPC^{A} (1)

where CPC^{A} represents an advertiser's bid (e.g., in a first-price auction) or a bid of a second highest bidder (e.g., in a second-price auction), and p(click|A, seen) represents a click-through probability or click-through-rate (CTR). As used herein, “click-through-rate” or “click-through probability” may be used interchangeably and may refer to a statistical probability that a search engine user will click on the advertisement A, given that the user looks at it. It should be noted that a CTR may or may not be normalized for its position or slot within a listing of sponsored search advertisements. As will be seen, a publisher may make such expected user behavior predictions based, at least in part, on historical click-through rates for advertisements that were displayed a number of times. As a way of illustration, a CTR for established advertisements (e.g., that were displayed a statistically significant number of times) may be calculated, at least in part, by the use of a maximum likelihood estimation technique that may be represented as the number of clicks divided by the total number of impressions or views, for example.

In addition, for newly created advertisements that may have no historical click-through data and/or for obscure or infrequently searched terms, a publisher may employ one or more models and/or functions, learned or otherwise (e.g., statistical, rule-based, etc.), to reasonably estimate a future CTR. As one possible example, for advertisements with no prior click-through data, a CTR may be estimated by using a CTR of established advertisements with the same search terms and/or keyword clusters. Another possible example for estimating an expected CTR may comprise utilizing one or more logistic regression models (e.g., query-dependent, query-independent, keyword clustering integration model, etc.). To illustrate, such user behavior predictions may be derived from various data directly associated with a displayed advertisement itself, such as, for example, a title of the advertisement, a text description, a web page the advertisement directs or points to (e.g., a display Uniform Resource Locator and/or its domain), view and/or click statistics of related advertisements, etc. Optionally or alternatively, a publisher may utilize, at least in part, a click-to-sale-conversion probability as a predictive click-estimate for winner determination and/or slot allocation. It should be noted, however, that these are merely illustrative examples relating to statistical probabilities or estimated CTRs that may be implemented in contract auctions for sponsored search advertising and that claimed subject matter is not limited in this regard.

As mentioned above, in sponsored search auctions advertisers may report to a publisher their willingness to pay or subjective values (e.g., per-click bids, per-impression bids, etc.) for the auctioned inventory or space. Different advertisers, however, may have different valuations regarding search engine users' clicks, purchases, and/or views or impressions. For example, advertisers building brand awareness (e.g., brand advertisers) may place value on having their advertisements displayed simply because this may increase their chance to make an impression on a potential customer, as previously mentioned. Certain advertisers may value immediate revenue represented by purchases and may prefer per-action payments as a result. Some advertisers, such as, for example, direct response advertisers, may place value on clicks because clicks may indicate potential customers (e.g., age, demographics, contexts, etc.). From a publisher's perspective, however, a relevant value may correspond most directly to bids representative of revenue that a publisher may collect on instances where a search engine user performs a search on a particular keyword. In addition, truth-telling in reporting valuations may not be a dominant strategy for advertisers, which may cause volatile prices and allocative inefficiencies (e.g., via pass-through costs of gaming the auction) that may be detrimental for a publisher's revenue.

As previously mentioned, an advertisement provider or publisher may employ one or more techniques or processes to account, for example, for such arbitrary distribution of values and/or to induce truthful bidding behavior of advertisers. As will be shown, a publisher may implement one or more contract auctions that may generalize a single-item second-price (e.g., Vickrey) auction so as to establish incentive compatibility together with a novel consistency condition between a publisher's and advertisers' values. To illustrate, each party's subjective values for a transaction (e.g., displaying an advertisement, per-click payments, etc.) may differ and may depend on the party's estimated CTR for a particular advertisement, as previously mentioned. Even though sponsored search auctions may—although not necessarily—assume agreement on CTRs, disagreements between a publisher and advertisers may arise. For example, clicks on advertisements may be considered low probability events and their rate of arrival may be hard to accurately estimate, as discussed above. In addition, even established advertisements may exhibit periodic and/or inconsistent behavior and, because of this, a variance of CTR estimates may be quite high. Estimated CTRs may also diverge because of a click fraud in which an advertiser may click on a competitor's advertisements in order to deplete the latter's budget. In such a case, a publisher and an advertiser may disagree which clicks were fraudulent. Accordingly, it may be desirable to develop one or more techniques and/or processes that may account, for example, for mismatched or otherwise uncertain probability estimates and may allow publishers to yield larger revenues while discouraging misrepresentation of advertisers' true willingness to pay when bidding (e.g., an auction is truthful).

Here, for example, a publisher may implement a contract auction with one or more impression-plus-click (IPC) bidding and/or pricing mechanisms in which each participating advertiser may submit a multi-dimensional or combined bid having a deterministic or fixed cost component (e.g., known in advance and/or having the same statistically ascertainable value to a publisher and an advertiser) and a stochastic cost component, as will be seen. As the term used herein, “stochastic cost component” may refer to any parameter of interest that may not be known, precisely or otherwise, in advance of a transaction between a publisher and an advertiser, and the expected value of which may depend on each party's probability distribution associated with such a parameter of interest. More specifically, an advertiser may submit an IPC bid having an advertiser's cost-per-impression (CPM) valuation (e.g., fixed cost component) and a cost-per-click (CPC) valuation (e.g., stochastic cost component), or (CPM+CPC) bid, with the understanding that an advertiser will pay a fixed amount per impression and may pay an additional amount if an advertisement is clicked. In some implementations, when an advertiser's estimated CTR is higher than a publisher's estimated CTR (e.g., disagreement is present), both parties may find negative click payments advantageous. As used herein, “negative payments” may refer to a transaction model in which an advertiser pays a publisher a premium for an impression, and the publisher then may pay the advertiser per click.

As illustrated in the example implementations of the present disclosure, a publisher, then, may estimate its own utility (e.g., expected revenue) for individually submitted IPC bids, and may determine a winner of an auction by identifying a bid (e.g., among acceptable bids) for which a publisher has maximum value. As one example among many possible, such maximum value acceptable bid may be determined, at least in part, by multiplying publisher's estimated probability of a click (CTR) by an advertiser's per-click valuation (CPC) and adding an advertiser's value per-impression (CPM), as will be shown. A final IPC price for a winning bid may be determined, for example, by appropriate adjustment (e.g., decreasing, etc.) of either the CPM or the CPC of the highest value IPC bid to the publisher. As such, a publisher and a winning advertiser may enter into the best advertising contract from the winning advertiser's perspective for which it would have still won the auction.

It should be appreciated that contract auctions for sponsored search may be extended beyond IPC auctions, for example, to integrate or otherwise account for a cost-per-action (CPA) bidding and/or pricing model (e.g., CPM+CPC+CPA auctions), as will be seen. Of course, this is merely one possible example related to applications of contract auctions for sponsored search advertising, and claimed subject matter is not so limited. Many models and/or applications of contract auctions for sponsored search, such as, for example, applications to insurance, book publications, and/or executive compensation may also be implemented.

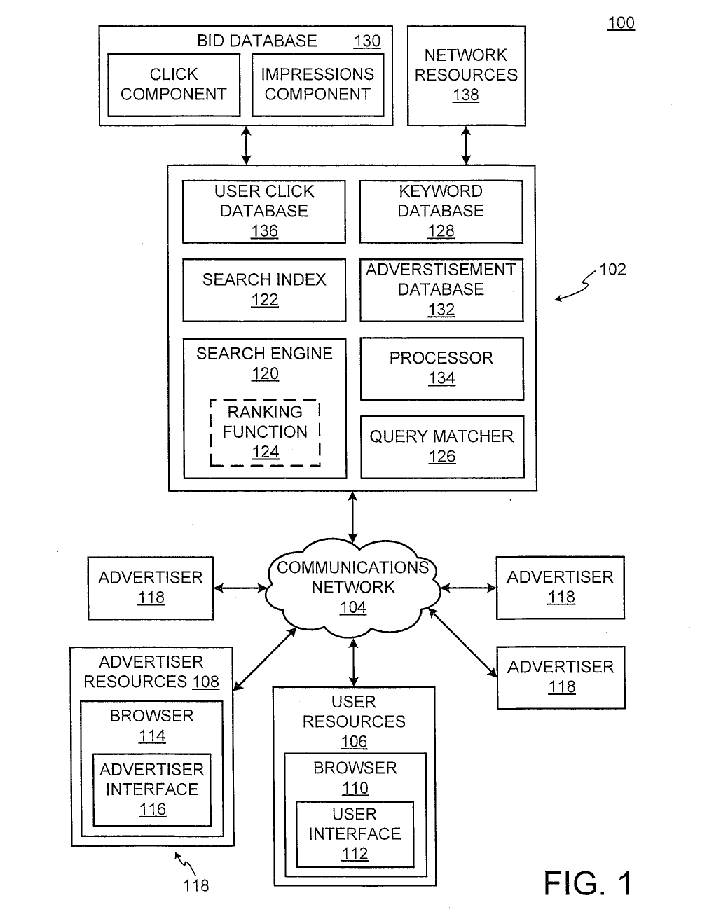

With this in mind, attention is now drawn to FIG. 1, which is a schematic diagram illustrating certain functional features and/or processes associated with an example computing environment 100 that may be operatively enabled to perform contract auctions for sponsored search advertising. Example computing environment 100 may be operatively enabled using one or more special purpose computing apparatuses, data communication devices, data storage devices, computer-readable media, applications, and/or instructions, various electrical and/or electronic circuitry and components, input data, etc., as described herein with reference to particular example implementations.

As illustrated in the present example, computing environment 100 may include an Information Integration System (IIS) 102 that may be associated with one or more advertisement providers or publishers and may be operatively coupled to a communications network 104. One or more search engine users and advertisers may employ respective user resources 106 and advertiser resources 108 to communicate with IIS 102. It should be appreciated that IIS 102 may be implemented in the context of one or more search systems associated with public networks (e.g., the Internet, the WWW), private networks (e.g., intranets), public and/or private search engines and websites, Real Simple Syndication-based (RSS) and/or Atom Syndication-based applications and/or websites, or the like.

User resources 106 and advertiser resources 108 may comprise, for example, any kind of computing device, mobile device communicating or otherwise having access to the Internet over a wireless network (e.g., notepads, personal digital assistants, cellular phones, etc.), or the like. User resources 106 may include a browser 110 and a user interface 112 that may allow a search engine user to submit a search term or query and to view a listing of returned search results and/or sponsored advertisements, as previously described.

In some implementations, advertiser resources 108 may include a browser 114 and an advertiser interface 116 to initiate a transmission of one or more electrical digital signals representing advertisers' bids, as will be seen. Even though only a certain number of advertisers 118 are illustrated in FIG. 1, it should be appreciated that any number of advertisers 118 may be operatively coupled to IIS 102 via communications network 104. Advertisers 118 may utilize any suitable advertiser resources, browser-based or otherwise, to communicate any relevant information to IIS 102 (e.g., selected keywords, bids, advertisements, billing information, etc.).

It should be noted that browsers 110 and 114 may facilitate access to and viewing of web pages over the Internet (e.g., HTML, etc.) and/or web pages specifically formatted for mobile devices (e.g., WML, XHTML Mobile Profile, WAP 2.0, C-HTML, etc.). User interface 112 and advertiser interface 116 may comprise any appropriate input means (e.g., keyboard, mouse, touch screen, digitizing tablet, etc.) and output means (e.g., display, speakers, etc.) suitable for an interaction with the respective resources.

IIS 102 may further include a search engine 120 supported by a search index 122 and operatively enabled to search for and/or help index data associated with web documents. For example, search index 122 may maintain a mapping of advertisements to queries and/or selected keywords in order to quickly identify and/or match relevant advertisements upon a real-time querying. As used herein, “real time” may refer to amount of timeliness of data or information which has been delayed by an amount of time attributable to electronic communication and automatic data processing. Such matching and/or mapping may be facilitated by utilizing one or more known techniques and/or algorithms, such as, for example, Karp-Rabin, Boyer-Moore, Knuth-Morris-Pratt algorithms, etc., and need not be described here in greater detail. Of course, claimed subject matter is not limited to these particular examples.

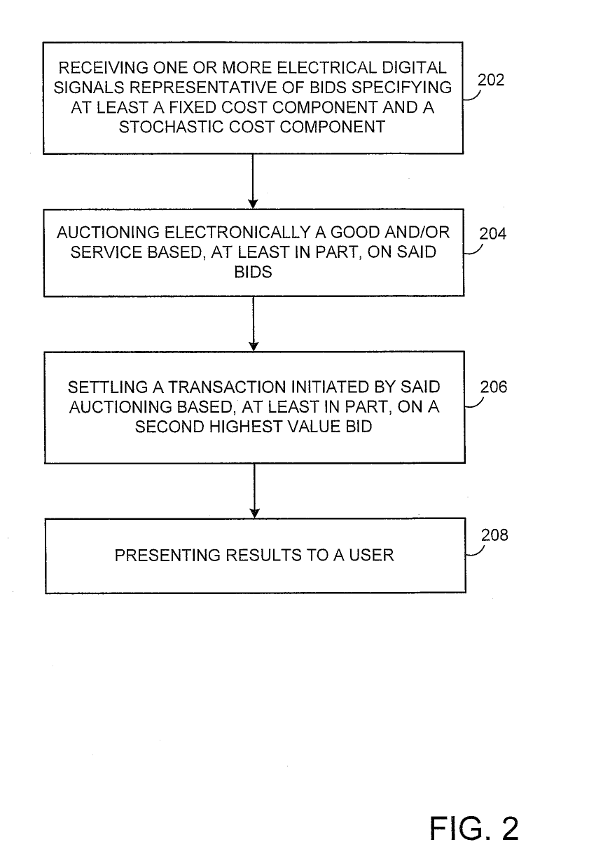

As previously mentioned, search engine 120 may determine whether a particular search term relates to one or more web documents and/or advertisements and may retrieve and display (e.g., via user interface 112) a web page with a listing of relevant search results and/or sponsored advertisements in response to a real-time query. In addition to efficiently retrieving information, search engine 120 may employ one or more ranking functions, such as, for example, a ranking function, indicated generally in dashed lines at 124, to rank a retrieved listing of search results in an order that may be based on their relevance, usefulness, popularity, web traffic, recency, and/or some other measure. In some implementations, ranking function 124 may facilitate a selection (e.g., winner determination) and/or ranking of sponsored search advertisements based, at least in part, on an expected revenue function applied to advertisers' bids, as will be described in greater detail with reference to FIGS. 2-5. In addition, ranking function 124 may be enabled to adjust bid amounts to arrive at a final IPC pricing according to one or more techniques and/or processes associated with contract auctions for sponsored search advertising, as will also be shown. It should be noted that ranking function 124 may be included in search engine 120, as illustrated, and/or otherwise may be operatively coupled to it.

Search engine 120 may further be operatively coupled to a query matcher 126 that may be enabled to determine which search terms or queries may be relevant and/or related to a particular keyword that advertisers may be interested in (e.g., placed their bids). Such a query matching may be performed using various known techniques and/or processes that may improve and/or otherwise positively affect matching of a query against a set of keywords selected by one or more advertisers. Query matcher 126 may utilize, for example, one or more concept-based or natural language processes to determine a relationship (e.g., semantic, linguistic, logical, etc.) between inputted search terms and selected keywords. Of course, this is merely one possible example. Many forms of query matching techniques or processes may be employed.

As previously mentioned, advertisers may select and submit to IIS 102 one or more desired keywords on which advertisers wish to place their bids (e.g., associated with their products, businesses, etc.) that may be subsequently stored in a keyword database 128. It should be noted that advertisers may select keywords from an offered (e.g., by a publisher) list of available keywords that may be pre-stored in keyword database 128. Optionally or alternatively, advertisers may be able to select desired keywords that may not be pre-stored in keyword database 128.

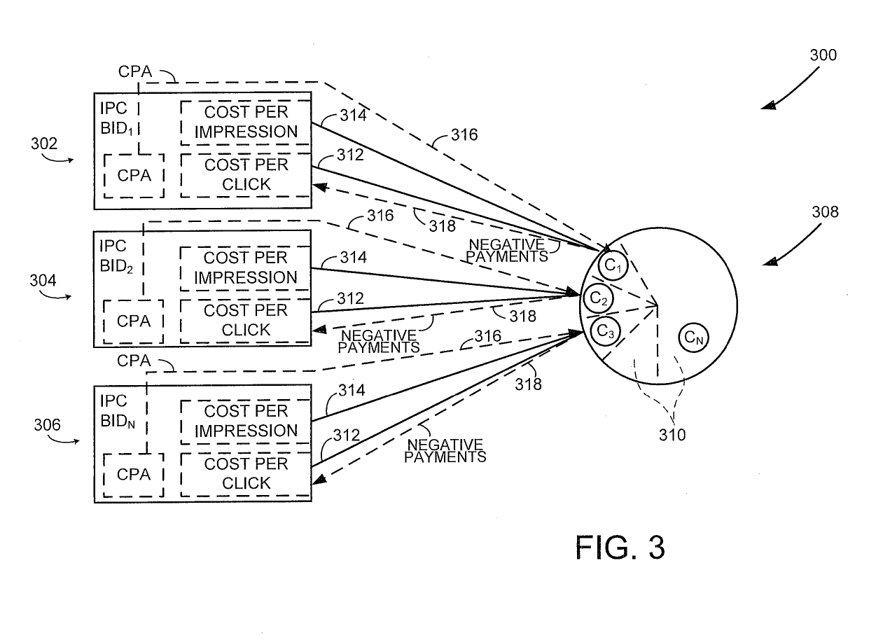

In some example implementations, IIS 102 may be operatively enabled to receive one or more electrical digital signals representing one or more advertisers' bids transmitted via communications network 104. Here, for example, advertiser interface 116 may initiate or otherwise enable the transmission of such electrical digital signals representing one or more combined IPC bids, at least one bid having a fixed cost component and a stochastic cost component, as previously mentioned. An example implementation of a process for submitting and/or pricing of combined IPC bids for contract auctions will be described in greater detail below with reference to FIGS. 3-5. Once submitted, such bids may be stored in a bid database 130. It should be appreciated that one or more electrical digital signals representing cost components (e.g., CPC, CPM, etc.) of a combined IPC bid may be stored separately within bid database 130, as illustrated. Optionally or alternatively, such components may be stored as a combination of values (e.g., CPC+CPM, etc.) for each separate IPC bid and may be partitioned by search engine 120 upon retrieval, for example. Although not shown, bid database 130 may include other suitable fixed and/or stochastic cost components (e.g., CPA) that may be utilized by a publisher to facilitate contract auctions for sponsored search advertising. As will be seen, such components may be also submitted by one or more advertisers 118 and may be stored in bid database 130.

As discussed above, advertisers 118 may submit their respective advertisements that may correspond to and/or otherwise be associated with submitted bids and may be stored in an advertisement database 132. Advertisement database 132 may comprise any type of data repository or data storing and/or processing device suitable for its intended purpose. In some implementations, advertisement database 124 may be operatively coupled to a processor 134 to perform one or more processes associated with managing and/or maintaining respective advertising accounts (e.g., set daily advertising budgets, maintain billing and address information, etc.). Processor 134 may be operatively enabled to execute computer-readable instructions and/or implement various modules, for example, to facilitate one or more processes associated with example computing environment 100. In addition, processor 134 may enable one or more advertisers to communicate with IIS 102 and/or advertisement database 132 to specify particular types of advertisements (textual, graphical, audio, etc.) that advertisers wish to present to a search engine user on search results pages returned in response to a query.

In some implementations, additional information tracking a search engine user's behavior may be collected, stored, and/or utilized by IIS 102. For example, such information may comprise user selections (e.g., clicks) of sponsored search advertisements during search sessions (e.g., historical click-through data) and may be stored in a user click database 136. As previously mentioned, such user behavior, as indicated by click-through data, may be utilized to estimate a CTR for a given advertisement. Techniques and/or processes associated with collecting and/or utilizing click-through data are known in the art and need not be described here with greater particularity. In addition, user click database 136 may be operatively enabled to link specific bid amounts with one or more winning advertisers (e.g., per each position or slot) and may be utilized to charge such advertisers, for example, in the event of a search engine user clicking on or otherwise selecting their respective advertisements and/or completing a particular transaction, as mentioned above.

In the configuration shown, IIS may be operatively enabled to access network resources 138 and locate one or more web documents associated with advertisers' web sites, web pages, and/or the like. Network resources 138 may include any organized collection of any type of data accessible over the Internet and/or associated with intranets (e.g., web documents, web sites, databases, discussion forums or blogs, query logs, audio, video, image, or text files, and/or the like).

In operative use, one or more advertisers 118 may access a publisher's website (e.g., via a search engine), for example, and may submit combined IPC bids, one or more selected keywords, and/or corresponding advertisements by utilizing advertiser resources 108. Browser 114 may initiate communication of one or more electrical digital signals representing such bids from advertiser resources 108 to IIS 102 via communications network 104. As a user via user resources 106 submits a query, IIS 102 may look up search index 122 and may establish a listing of web documents based on relevance according to ranking function 124. Query matcher 126 may match the submitted query to keywords selected by advertisers by accessing keyword database 128 and may extract one or more keywords that match such a query.

IIS 102 may associate extracted keywords with one or more corresponding advertisements by accessing advertisement database 132. Ranking function 124, then, may retrieve and/or rank such advertisements according to one or more techniques and/or processes that may be based, at least in part, on an expected revenue function of advertisers' bids retrieved from bid database 130. To facilitate such one or more processes, ranking function 124 may order and/or receive a historical click-through data for a particular keyword, if available, from user click database 136. IIS 102 may then combine retrieved advertisements with search results and may communicate a search results web page to user resources 106 for displaying ranked results and/or sponsored advertisements on user interface 112.

It should be appreciated that some or all elements described herein with reference to computing environment 100 may or may not be separate from IIS 102, and may comprise one or more servers that may be supported by one or more stand-alone and/or distributed networks that may be operatively enabled to facilitate one or more processes associated with contract auctions for sponsored search advertising.

FIG. 2 is a flow diagram illustrating an example process 200 for performing contract auctions for sponsored search advertising according to one implementation. The example process may begin with advertisers submitting or otherwise communicating multi-dimensional or combined IPC bids to a publisher (e.g., search engine) utilizing advertiser resources. A browser associated with the advertiser resources may initiate communication of the bids as one or more electrical digital signals over a communications network. As the term used herein, “communicate,” “submit,” “report” may be used interchangeably and may refer to transmission and/or receipt of any type of data, such as, for example, an exchange of data occurring between the computing platforms of a publisher and one or more advertisers associated with process 200.

One or more electrical digital signals representative of such bids may be received at operation 202, for example, by a server or other device (e.g., computing platform, etc.). As previously discussed, each IPC bid may be classified as a multi-dimensional or combined bid having or specifying a deterministic or fixed cost component and a stochastic cost component. As a way of illustration, then, each advertiser may submit an IPC bid in which an advertiser may specify, for example, its willingness to pay per-click (e.g., CPC) and to pay per-impression (e.g., CPM), or IPC bid=CPC (e.g., fixed cost)+CPM (e.g., stochastic cost). Of course this is just one possible example of a multi-dimensional or combined bid that may be used to which claimed subject matter is not limited.

Turning now to FIG. 3, which is a diagram further illustrating the process of FIG. 2 in a non-limiting example implementation where a participating advertiser may express its valuations via a combined or multi-dimensional bid. Namely, such a process 300 may include any number of participating advertisers, such as, for example, a first advertiser 302, a second advertiser 304, and so forth up through an Nth advertiser 306 any of which may report their respective valuations, for example, in the form of a function parametrized by the set of valuation features, to a publisher 308. As seen, publisher 308 may have, for example, a finite set of possible contract spaces or contracts C₁, C₂, C₃ . . . , C_{N} on its search results web page (e.g., advertising positions, slots, etc.), indicated generally in dashed lines at 310. Even though contract spaces may, although not necessarily, be considered as finite, for example, to achieve maximum operation of process 300 (e.g., maximize publisher's revenue, etc.), it should be appreciated that a publisher may achieve the maximum value in an auction with infinite contract spaces. Here, publisher 308 may wish to enter into an impression-plus-click (IPC) contract, for example, for which the publisher has a maximum value, as previously mentioned. As used in the context of the present disclosure, a “contract” may refer to one or more abstract objects that may represent an advertising space, in an on-line marketplace or otherwise, for which each party (e.g., an advertiser and an advertisement provider or publisher) has a value.

As mentioned above, an advertiser may submit or report to publisher 308 their entire valuation function to bid on a potential IPC contract (e.g., advertising slot, etc.) that is defined, at least in part, by a pair of extremal (e.g., set at advertisers' price caps and/or budget limits) CPC and CPM contracts. As seen, these valuation functions may be expressed in the form of a combined or multi-dimensional IPC bid that specifies, for example, a maximum amount an advertiser is willing to pay per click (e.g., CPC contract), as shown at 312, and per impression(s) (e.g., CPM contract), as indicated generally at 314. It should be appreciated that in a larger class of contract auctions for sponsored search, an advertiser may report a larger set of parameters (e.g., contracts) that may define a valuation function over an entire advertising space. As a way of illustration, in such a case, in addition to reporting their valuations as CPC and CPM contracts, advertisers may submit their valuations on actions of search engine users (e.g., cost-per-action or CPA contract), or CPC+CPM+CPA, as one non-limiting example among many possible.

Here, by way of example but not limitation, advertisers may have valuation functions vᵢ:Cᵢ [symbol] H for their respective contracts Cᵢ and a publisher's value for a potential contract Cᵢ is given by vᵢ^{A}:Cᵢ [symbol] To bid on an IPC contract, then, an advertiser Aᵢ may report to a publisher its entire valuation functions determined by the pair of extremal CPC and CPM contracts

{(rₘⁱ,CPCᵢ),(CPMᵢ,r_{c}ⁱ)}, (2)

where advertiser's per-impression value for the IPC contract rₘⁱ=pᵢ(wᵢ−CPCᵢ) and per-click value r_{c}ⁱ=wᵢ−CPMᵢ/pᵢ, in which wᵢ represents a value-per-click of each advertiser Aᵢ, pᵢ represents estimated (e.g., by a publisher) CTR, and CPMᵢ and CPCᵢ respectively represent advertisers' price caps on impressions and clicks. It should be noted that in certain example implementations, it may be that CPC and CPM contracts are taken so as to represent only the highest or maximum value to a publisher, as previously mentioned. For example, the highest value contract from the publisher's perspective may be one for which the advertiser has zero utility (e.g., in which an advertiser's valuation and its budget are the same). Thus, consider:

vᵢ(rₘⁱ,CPCᵢ)=0 vᵢ(CPMᵢ,r_{c}ⁱ)=0 (3)

Accordingly, each advertiser, then, may report to a publisher their respective valuation functions for the IPC contract as the following:

\tilde{v}ᵢ={(r_{m,1}ⁱ,r_{c,1}ⁱ),(r_{m,2},r_{c,2}ⁱ)} (4)

where r_{m,1}ⁱ≦0<r_{m,2}ⁱ and r_{c,2}ⁱ≦0<r_{c,1}ⁱ as previously noted.

In some implementations, participating advertisers may submit bids for the IPC contract with the understanding that negative click payments 318 may be implemented. For example, as described above, a publisher and an advertiser may have different inherent valuations for an IPC contract, such as, for example, mismatched probability estimates pₕ₍₁₎^{A}<pₕ₍₁₎ where a publisher's estimated CTR for an impression awarded to an advertiser is less that an advertiser's subjective CTR. In such a case, an advertiser may wish to pay more per impression (e.g., a premium) and a publisher, then, may pay advertiser every time the advertisement is clicked. As will be seen, such negative click payments 318 may be implemented so that a final value of the IPC contract to the publisher remains maximized.

Referring back to the flow diagram of FIG. 2, at operation 204, having received signals representative of bids for the IPC contract from participating advertisers, a publisher's computing platform may auction one or more goods and/or services based, at least in part, on the received bids. In certain implementations, goods and/or services may refer to on-line advertising inventory or space that may be available on a web page operated and/or otherwise associated with a publisher. For example, such goods and/or services may refer to advertising inventory or space available on the Internet or an intranet, which may or may not include being accessible via the World Wide Web, as previously mentioned. Furthermore, on-line advertising inventory may also represent not just the advertising space itself, but also particular characteristics and/or attributes of such advertising inventory, such as, for example, its content, size, positioning, and/or audience demographic or behavioral characteristics or attributes. Of course, these are merely examples relating to on-line advertising inventory and claimed subject matter is not limited to these particular examples.

In some implementations, however, auctioned goods and/or services need not be related to on-line transactions or represent web page space at all. As a way of illustration, such goods and/or services may comprise objects of interest that may be associated with one or more contract-related and/or business-related transaction models (e.g., negotiations, licensing, etc.) in which parties may have conflicting information and/or different inherent values for a specific term of a contract and/or transaction. For example, in certain situations, parties may engage in off-line negotiations that may involve bargaining between deterministic or fixed payments and stochastic payments, and, thus, one or more processes similar to a contract impression-plus-click auction may be implemented. To illustrate, in negotiations related to book publishing (e.g., book publication services), a publisher and an author may negotiate a transaction in terms of a one-time advance (e.g., fixed cost component) and royalties or back-end fees (e.g., stochastic cost component) to optimize or otherwise account for uncertainties (e.g., risks) between the parties. Likewise, in licensing agreements (e.g., licensing services), for example, for a resource or property of interest (e.g., intellectual property, land use rights for minerals or petroleum, etc.), parties may consider fixed usage-based payments (e.g., fixed cost component), such as, for example, a payment for practicing one or more intellectual property rights or extracting a resource (e.g., drilling) and royalty payments of future production and/or revenues or resultant profits (e.g., stochastic cost component). There may also be other instances and/or transactions in which fixed cost and stochastic cost components may be implemented, such as, for example, premiums (e.g., fixed cost component) and deductibles (e.g., stochastic cost component) for insurance industry, salaries (e.g., fixed cost component) and performance-based bonuses (e.g., stochastic cost component) for executive compensation models, etc. It should be noted, however, that these are merely illustrative examples relating to various deterministic or fixed and stochastic cost components representative of goods and/or services that may be utilized in contract auctions at operation 204, and that claimed subject matter is not limited in this regard.

As previously mentioned, a statistical probability, such as, for example, a CTR, may be applied by a publisher to a stochastic cost component to reasonably estimate expected value of the future clicks. It should be appreciated that one or more parties participating in off-line transactions may implement similar process and/or mechanism and may apply one or more statistical probabilities to a parameter of interest so as to maximize the expected value of their objective. For example, book publishers may apply a probability of a future success of a particular book and/or author to future royalty payments, insurer may consider a probability of a particular driver getting into an accident, etc. Of course, these are just examples to which claimed subject matter is not limited.

Publisher's computing platform may auction such goods and/or services in a variety of ways that may be based, at least in part, on communicated valuation functions parametrized by the set of contract pairs, as previously mentioned. For example, a publisher may auction off goods and/or services by selecting a winning advertiser who submitted the IPC contract with the highest value to the publisher (e.g., from the publisher's perspective). Such a contract, for example, may be determined, at least in part, by estimating publisher's utility representative of a publisher's expected revenue with respect to each reported valuation. From the publisher's perspective, then, the utility of an IPC contact with an advertiser Aᵢ may be generally estimated as:

vᵢ^{A}(rₘ,r_{c})=rₘ+pᵢ^{A}r_{c}, (5)

where pᵢ^{A} is the publisher's estimated CTR for a particular advertisement. As previously discussed, expected CTR determination may be calculated, at least in part, via one or more models of logistic regression, for example.

Likewise, for each reported valuation for an IPC contract (rₘ, r_{c}), then, a publisher may identify a winning contract with a maximum utility or value Rᵢ that the publisher may achieve from each advertiser among all acceptable contracts (e.g., with zero utility to advertisers, etc.), or:

$$\begin{matrix}{R}_{i} = max ( {v}_{i}^{A} ( {r}_{m , 1}^{i} , {r}_{c , 1}^{i} ) , {v}_{i}^{A} ( {r}_{m , 2}^{i} , {r}_{c , 2}^{i} ) ) \\ = max ( {r}_{m , 1}^{i} + {r}_{c , 1}^{i} {p}_{i}^{A} , {r}_{m , 2}^{i} + {r}_{c , 2}^{i} {p}_{i}^{A} ) .\end{matrix} \qquad ( 6 )$$

With regard to operation 206, a system or process may further execute instructions on the special purpose computing apparatus to settle a transaction, such as, for example, an IPC auction based, at least in part, on a second-highest value bid or IPC contract. As used herein, a “second highest value” may refer to the value of the best or highest value bid or IPC contract among those submitted by the losing advertisers from the publisher's perspective (e.g., publisher's estimated utility). Such a pricing may provide a dominant strategy incentive compatible mechanism that may create an incentive for advertisers to truthfully report their valuation functions for the IPC contracts, thus, reducing or eliminating strategic bidding behavior. For example, a publisher may implement a pricing mechanism where the payment of a winning advertiser may not directly depend on its bid and/or where publisher's values of the final IPC contracts in contract auction with 1 through Nth advertisers, for example, may be tailored such that:

Rₕ₍₁₎≧Rₕ₍₂₎≧ . . . ≧R_{h(N)}

In this illustrated example, having identified the second best or highest value contract—from the perspective of the publisher—the final contract IPC price may be determined. For example, if the highest value contract has higher CPM than the winning advertiser's other contract or bid, then the final IPC contract may be determined by adjusting or decreasing the CPC on the highest value contract until the publisher's value for that contract is equal to the second highest value. Likewise, if the highest value contract has lower CPM than the winning advertiser's other bid, the final IPC contract may be determined by adjusting or decreasing the CPM of the highest value contract. A final IPC contract c* may, for example, be determined as follows:

$${c}^{*} = \{ \begin{matrix}( {r}_{m , 2}^{h ( 1 )} , ( {R}_{h ( 2 )} - {r}_{m , 2}^{h ( 1 )} ) / {p}_{h ( 1 )}^{A} ) & if {R}_{h ( 1 )} = {v}_{h ( 1 )}^{A} ( {r}_{m , 2}^{h ( 1 )} , {r}_{c , 2}^{h ( 1 )} ) \\ ( {R}_{h ( 2 )} = {p}_{h ( 1 )}^{A} {r}_{c , 1}^{( 1 )} , {r}_{c , 1}^{h ( 1 )} ) & otherwise\end{matrix} \qquad ( 7 )$$

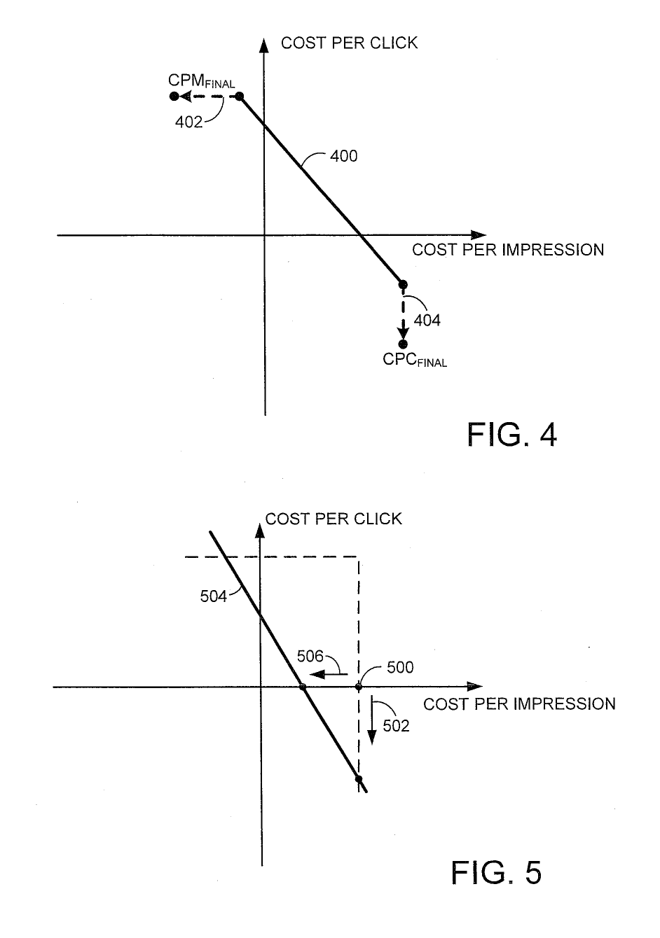

Determination of the final IPC contract is illustrated in FIGS. 4-5. As particularly seen in the CPM-CPC price plane of FIG. 4, a final contract may be arrived at by decreasing either the CPM or the CPC (e.g., but not both) of the highest value contract to the publisher off the publisher's expected revenue level line 400, as illustrated by respective dashed arrows 402 and 404.

As previously mentioned, a publisher and an advertiser may have mismatched probability estimates, such as, for example, where pₕ₍₁₎^{A}<pₕ₍₁₎ (e.g., publisher's estimated CTR is less that an advertiser's). In such a case, a publisher, for example, may prefer a winning advertiser's pure per-impression contract or bid over its pure per-click bid. In this example, both parties may find negative click payments advantageous where an advertiser may pay per impression (e.g., a premium), but a discount may be given to the advertiser via such negative click payments (e.g., the publisher pays the advertiser per click). It should be noted that such negative click payments may be calculated so that the final value of the IPC contract to the publisher may remain unchanged (e.g., utility or expected revenue is the same). As illustrated in FIG. 5, the final IPC contract implementing negative click payments where pₕ₍₁₎^{A}<pₕ₍₁₎ may be determined, at least in part, by moving pure-impression contract 500 down parallel to the CPC axis of the CPM-CPC price plane, as indicated by arrow 502, to meet the publisher's expected revenue level line 504. In certain situations, for example, when pₕ₍₁₎^{A}<pₕ₍₁₎, a publisher may prefer a pure-click contract or bid, and the IPC auction may arrive at the final contract by moving left parallel to the CPM axis, as shown by arrow 506, thus, corresponding to negative impression payments. Accordingly, a publisher and a winning advertiser may enter into the best advertising contract from the winning advertiser's perspective for which it would have still won the auction.

It should be appreciated that negative payments may also be applicable to and may be implemented in many off-line transactions, such as, for example, in contract-related and/or business-related negotiations where parties may bargain between deterministic or fixed payments and stochastic payments, as previously mentioned. For example, with book publication, authors confident in the future success of their books may be willing to trade an advance payment for larger percentage of total sales revenue (e.g., royalties) or to pay to have their book published in exchange for a higher percentage of the sales revenue. Likewise, an insured may be willing to pay a high premium, for example, for earthquake insurance in exchange for a ‘disaster bonus.” Of course, various implementations of specific processes and/or models similar to an IPC auction are possible, and the above examples are not intended to limit claimed subject matter to a particular implementation.

Finally, at operation 208 of FIG. 2, the process may further execute instructions on the special purpose computing apparatus to present a search results web page that may include a listing of ranked sponsored advertisements to a user. The results may be transmitted via a communication network as one or more binary digital signals to user resources and may be displayed in the user interface.

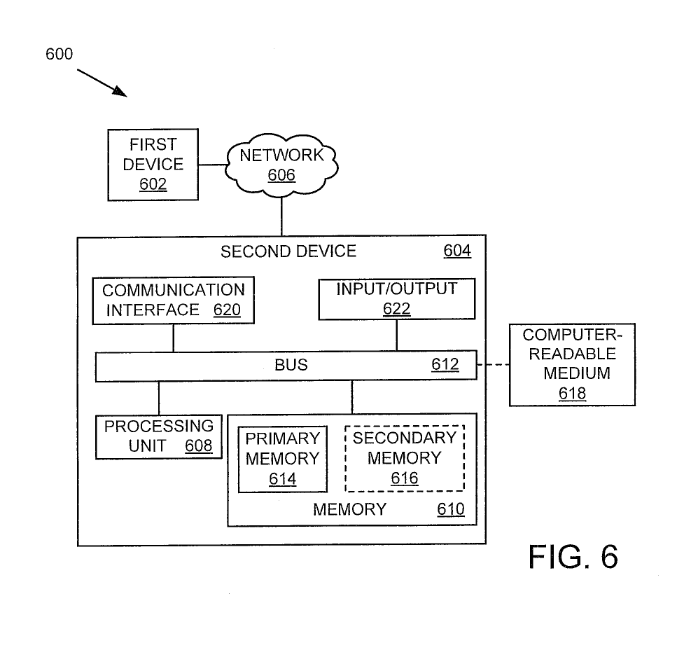

FIG. 6 is a schematic diagram illustrating an example computing environment 600 that may include one or more devices that may be configurable to partially or substantially implement a process for performing or running contract auctions for sponsored search advertising.

Computing environment system 600 may include, for example, a first device 602 and a second device 604, which may be operatively coupled together via a network 606. Although not shown, optionally or alternatively, there may be additional like devices operatively coupled to network 606

In an embodiment, first device 602 and second device 604 may be representative of any electronic device, appliance, or machine that may be configurable to exchange data over network 606. For example, first device 602 and second device 604 may include: one or more computing devices or platforms, such as, e.g., a desktop computer, a laptop computer, a workstation, a server device, data storage units, or the like.

Network 606 may represent one or more communication links, processes, and/or resources configurable to support exchange of data between first device 602 and second device 604. By way of example but not limitation, network 606 may include wireless and/or wired communication links, telephone or telecommunications systems, data buses or channels, optical fibers, terrestrial or satellite resources, local area networks, wide area networks, intranets, the Internet, routers or switches, and/or the like.

It should be appreciated that all or part of various devices and/or networks shown in computing environment system 600, and processes and/or methods as described herein, may be implemented using or otherwise include hardware, firmware, or any combination thereof along with software.

Thus, by way of example but not limitation, second device 604 may include at least one processing unit 608 that may be operatively coupled to a memory 610 through a bus 612. Processing unit 608 may represent one or more circuits to perform at least a portion of a data computing procedure or process. As a way of illustration, processing unit 608 may include one or more processors, controllers, microprocessors, microcontrollers, application specific integrated circuits, digital signal processors, programmable logic devices, field programmable gate arrays, and/or the like.

Memory 610 may represent any data storage mechanism. For example, memory 610 may include a primary memory 614 and a secondary memory 616. Primary memory 614 may include, for example, a random access memory, read only memory, etc. While illustrated in this example as being separate from processing unit 608, it should be appreciated that all or part of primary memory 614 may be provided within or otherwise co-located/coupled with processing unit 608.

Secondary memory 616 may include, for example, the same or similar type of memory as primary memory and/or one or more data storage devices or systems, such as, for example, a disk drive, an optical disc drive, a tape drive, a solid state memory drive, etc. In certain implementations, secondary memory 616 may be operatively receptive of, or otherwise enabled to be coupled to, a computer-readable medium 618. Computer-readable medium 618 may include, for example, any medium that can store and/or provide access to data, code and/or instructions for one or more devices in system 600.

Second device 604 may include, for example, a communication interface 620 that may provide for or otherwise support operative coupling of second device 604 to at least network 606. By way of example but not limitation, communication interface 620 may include a network interface device or card, a modem, a router, a switch, a transceiver, and/or the like.

Second device 604 may include, for example, an input/output device 622. Input/output device 622 may represent one or more devices or features that may be able to accept or otherwise input human and/or machine instructions, and/or one or more devices or features that may be able to deliver or otherwise output human and/or machine instructions. By way of example but not limitation, input/output device 622 may include a display, speaker, keyboard, mouse, trackball, touch screen, data port, and/or the like.

Thus, as illustrated in various example implementations and/or techniques presented herein, in accordance with certain aspects, a method may be provided for use as part of a special purpose computing device and/or other like machine that accesses digital signals from memory and processes such digital signals to establish transformed digital signals which may be stored in memory as part of one or more data files and/or a database specifying and/or otherwise associated with an index.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

According to an implementation, one or more portions of an apparatus, such as second device 604, for example, may store one or more binary digital electronic signals representative of information expressed as a particular state of a device, here, second device 604. For example, an electronic binary digital signal representative of information may be “stored” in a portion of memory 610 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, here, for example, memory device 610, to a different state or thing.

While certain example techniques have been described and shown herein using various methods and/or systems, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
receiving one or more electrical digital signals representative of bids specifying at least a fixed cost component and a stochastic cost component; and
auctioning electronically a good and/or service based, at least in part, on said bids.

2. The method of claim 1, wherein said auctioning is based, at least in part, on a utility function comprising a product of said fixed cost component and a statistical probability applied to said stochastic cost component, wherein said statistical probability is associated with said stochastic cost component.

3. The method of claim 2, wherein said statistical probability comprises at least one of the following: a click-through rate; a probability of an accident; a probability of a performance-based bonus; or a probability of sales-based revenues.

4. The method of claim 1, wherein said fixed cost component comprises at least one of the following: a cost per impression; an advance payment for goods and/or services; a premium for insurance; or a salary.

5. The method of claim 1, wherein said stochastic cost component comprises at least one of the following: a cost per click; a royalty fee for goods and/or services; a deductible for insurance; or a bonus.

6. The method of claim 1, wherein said auctioning electronically said good and/or service is performed, at least in part, via executing instructions by a special purpose computing apparatus.

7. The method of claim 1, and further comprising:
settling a transaction initiated by said auctioning based, at least in part, on a second highest value bid.

8. The method of claim 7, wherein said settling a transaction includes adjusting said fixed cost component.

9. The method of claim 7, wherein said settling a transaction includes adjusting said stochastic cost component.

10. The method of claim 1, and further comprising:
implementing at least one negative payment.

11. An article comprising:
a storage medium having instructions stored thereon executable by a special purpose computing platform to:
receive one or more electrical digital signals representative of bids specifying at least a fixed cost component and a stochastic cost component; and
auction electronically a good and/or service based, at least in part, on said bids.

12. The article of claim 11, wherein said storage medium further includes instructions to estimate a utility function calculated, at least in part, as a product of said fixed cost component and a statistical probability applied to said stochastic cost component, wherein said statistical probability is associated with said stochastic cost component.

13. The article of claim 12, wherein said statistical probability comprises at least one of the following: a click-through rate; a probability of an accident; a probability of a performance-based bonus; or a probability of sales-based revenues.

14. The article of claim 11, wherein said storage medium further includes instructions to settle a transaction initiated by said auction based, at least in part, on a second highest value bid.

15. The article of claim 11, wherein said storage medium further includes instructions to implement at least one negative payment.

16. An apparatus comprising:
a computing platform to:
receive one or more electrical digital signals representative of bids specifying at least a fixed cost component and a stochastic cost component; and
auction electronically a good and/or service based, at least in part, on said bids.

17. The apparatus of claim 16, wherein said computing platform is further enabled to settle a transaction initiated by said auctioning based, at least in part, on a second highest value bid.

18. The apparatus of claim 17, wherein said computing platform is further enabled to adjust said fixed cost component.

19. The apparatus of claim 17, wherein said computing platform is further enabled to adjust said stochastic cost component.

20. The apparatus of claim 16, wherein said computing platform is further enabled to implement at least one negative payment.
